(19) United States
(12) Patent Application Publication
(10) Pub. No.: US 2005/0071998 A1
(43) Pub. Date: Apr. 7, 2005

(54) Method of molding centrifugal impeller

(76) Inventors: Drew M. Rocky, Newtown, CT (US); Russel H. Marvin, Goshen, CT (US); Robert A. Hoyt, Bristol, CT (US)

Correspondence Address: Russel H. Marvin, CTO;Torrington Research Company, 89 Commercial Boulevard, Torrington, CT, 06790, US

(21) Appl. No.: 10/930,388

(22) Filed: Aug. 31, 2004

Related U.S. Application Data
(60) Provisional application No. 60/508,323, filed on Oct. 2, 2003.

(51) Int. Cl. F03B 1/00; F01D 1/02

(52) U.S. Cl. 29/889; 29/527.1; 29/889.7

(57) ABSTRACT

A method for plastic injection molding a centrifugal air impeller having a series of radially elongated air moving blades of varying width from root to tip and an inlet cover and back plate each of which takes a generally circular disc-like configuration with the former defining an air inlet opening and serving as a first housing element and the latter serving as a second axially spaced opposing substantially flat housing element. The inlet cover and air moving blades are molded integrally with the blades projecting axially from the cover and with the cover contoured as required to accommodate substantially all of the width variation in the blades in progression from root to tip. Thus, the longitudinal blade edges opposite the inlet cover reside substantially in a common plane facilitating the attachment of the integral inlet cover and blade assembly to the substantially flat back plate in face-to-face axial alignment.

### RELATED APPLICATION

Provisional application No. 60/508,323, titled “Improved Molding Method for Centrifugal Impeller Inlet Blade” filed Oct. 2, 2003, inventors Drew M. Rocky, Russel H. Marvin, Robert A. Hoyt, incorporated herein by reference.

### BACKGROUND OF THE INVENTION

Relatively small centrifugal air impellers and the like are commonly manufactured employing an injection molding process. Rearwardly curved centrifugal impellers and certainly other designs such as linear blades may have blades which are relatively narrow in axial dimension and relatively long in radial dimension and which may vary substantially in width as they progress from root to tip. In conventional injection molding practice, the blades are molded integrally with a backplate which may serve as both a housing half section and a driving element for the impeller. An inlet plate serves as the other half of the housing and is conventionally molded separately with an inlet opening. The inlet plate is then attached to the blades as by ultrasonic welding to complete the impeller. While this process is satisfactory in general, the attachment of the inlet plate to the blades may encounter serious problems. Due to the varying width of the blades the inlet plate must have a contoured or somewhat complex configuration and is usually of relatively thin construction. Perfect alignment of the contoured plate and the blades of varying width is difficult and flash often occurs along the joint between the blades and plate. Such flash is of course directly in the air stream and may not only affect performance but also cause contamination. It is the general object of the present invention to provide an improved molding process which is relatively simple to carry out and which results in a greatly improved structurally superior end product free of flash and other irregularities.

### SUMMARY OF THE INVENTION

In accordance with the present invention and in fulfillment of the foregoing object, the improved method of the invention comprises the steps of molding an inlet cover and impeller blades integrally with the blades projecting axially from the cover and with the cover contoured as required to accommodate substantially all of the width variation in the blades in progression from root to tip. Thus, the longitudinal blade edges opposite the cover reside substantially in a common plane. Now, when the latter blade edges are ultrasonically or otherwise attached to the backplate, perfect alignment is readily achieved and a superior weld or other attachment results.

In addition to the foregoing, energy directors may be provided in the form of narrow axially projecting ribs substantially along the length of the blade edges to be welded. Complementary grooves in the backplate receive the energy directors and welding occurs only in the grooves thus eliminating flash.

Further to insure precise location of the blades, locating pins may be provided on some of the blades with mating holes provided in the backplate.

### DESCRIPTION OF THE DRAWINGS

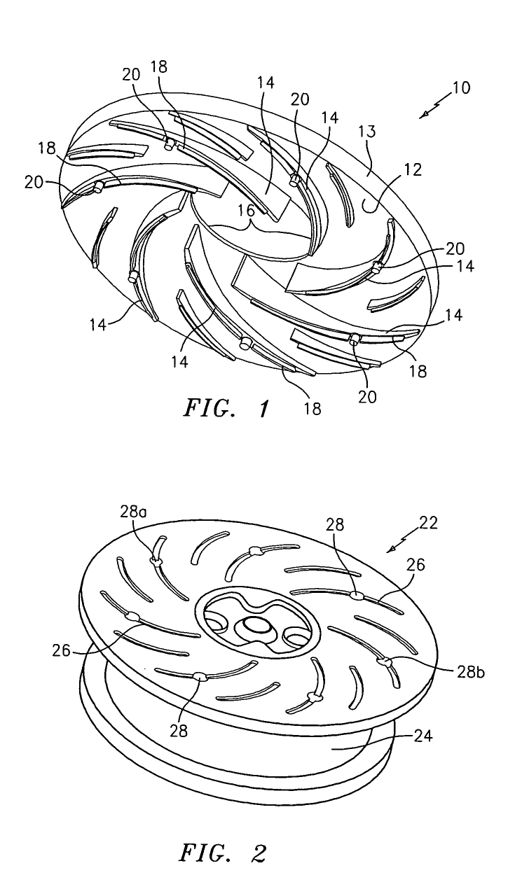

Referring particularly to FIG. 1, an inlet cover and impeller blade assembly indicated generally at 01 is of one piece integrally injection molded thermoplastic construction in accordance with the method of the invention. The cover 12 is of disc like configuration with an annular discharge defining rim 13 and is contoured to accommodate the width variation in impeller blades 14, 14 which extend radially outwardly from a central air inlet opening 16. The blades are a curved, elongated radially and relatively narrow axially shown with their inner ends substantially wider than their outer ends. Both longitudinal edges of the blades are shown as being substantially linear and it is expected that the free edges of the blades remote from the inlet cover will in all cases be linear for precise engagement with a flat backpate to be described herein below. The opposite longitudinal edges, however, adjacent the inlet cover may vary widely in configuration, the inlet cover being contoured accordingly.

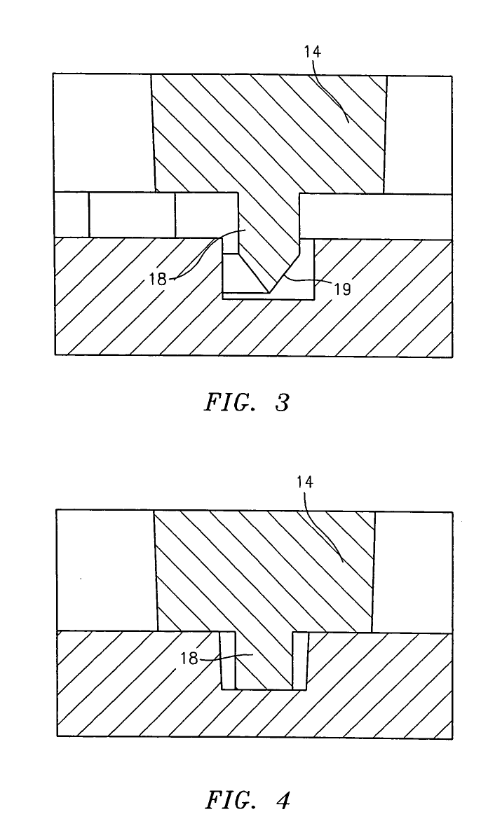

Formed substantially along the length of each of the blades 14 at its longitudinal edge opposite the cover plate is an energy director in the form of a narrow axially projecting rib 18 as best illustrated in FIG. 3, each rib 18 has a pointed end 19 for a purpose to be set forth below. Also formed on the blade edges opposite the cover plate 12 are a plurality of small locating pins 20, 20 which project axially from the blades and which serve a purpose to be set forth below.

A molded plastic backplate indicated at 22 in FIG. 2 takes a disc like configuration and may be integral with a housing 24 for a motor which drives the impeller. Arcuate grooves 26, 26 in the backplate correspond in number and configuration with the blades 14, 14 and ribs 18, 18 and are narrower than the blades to prevent entry of the same during welding.

When welding is to be accomplished, the aforementioned pins 20, 20 are entered into corresponding locating holes 28, 28 in backplate 22, 22 for precise positioning of the two parts. Hole 28a is somewhat smaller than the remaining holes to provide for a slip fit and hole 28b is slightly enlarged radially but provides a close fit circumaxially to prevent winging movement and thus provide a precise locating operation.

During ultrasonic welding the pointed portions 19, 19 of the energy directors or ribs 18, 18 melt and the edges of the blades 14, 14 engage the backplate as best illustrated in FIGS. 3 and 4 forming a clean flash free joint as desired.

As will be apparent from the foregoing, a relatively simple yet highly efficient method has been provided, the resulting impeller being of superior quality and high performance characteristics absent flash and other undesirable results from the molding process.

1. A method for plastic injection molding a centrifugal air impeller having an impeller with a series of radially elongated air moving blades of varying width from root to tip and an inlet cover and back plate each of which takes a generally circular disc-like configuration with the former defining an air inlet opening and as a first housing element and the latter serving as a second axially spaced opposing substantially flat housing element; the method comprising molding the inlet cover and air moving blades integrally with the blades projecting axially from the cover and with the cover contoured as required to accommodate substantially all of the width variation in the blades in progression from root to tip, the longitudinal blade edges opposite the inlet cover thus residing substantially in a common plane, and attaching the integral inlet cover and blade assembly to the substantially flat back plate in face-to-face axial alignment.

2. A method for plastic injection molding a centrifugal air impeller as set forth in claim 1 wherein the step of attaching the inlet cover and blades to the back plate is carried out in an ultrasonic welding operation.

3. A method for plastic injection molding a centrifugal air impeller as set forth in claim 2 wherein axially projecting ribs are molded along and substantially throughout the length of the longitudinal edges of the blades on a side thereof opposite the cover, and wherein mating grooves are provided in the back plate for entry of the ribs into the grooves on assembly and welding of the cover and blades to the back plate.

4. A method for plastic injection molding a centrifugal air impeller as set forth in claim 3 wherein the dimensional relationship between the ribs and grooves is such that the ribs enter wider grooves during molding but the grooves are narrower than the blades, the blade edges thus being prevented from entering the grooves and causing flash.

5. A method for plastic injection molding a centrifugal air impeller as set forth in claim 4 wherein small locating pins are provided on at least some of the blades with mating locating holes in the back plate for accuracy in assembling the cover and blades with the back plate.

6. A method for plastic injection molding a centrifugal air impeller as set forth in claim 5 wherein at least one par of the pins and holes is adapted for a slip fit.

7. A method for plastic injection molding a centrifugal air impeller as set forth in claim 6 wherein at least one hole is shaped to prevent its mating pin from moving circumaxially.

8. A method for plastic injection molding a centrifugal air impeller as set forth in claim 1 wherein the backplate is formed in a plastic molding operation.

9. A method for plastic injection molding a centrifugal air impeller as set forth in claim 1 wherein the cover is molded with a short axially extending annular rim about its perimeter which defines a discharge opening for the impeller.

10. A method for plastic injection molding a centrifugal air impeller as set forth in claim 1 wherein the blades are molded to a rearwardly curved configuration.

11. A method for plastic injection molding a centrifugal air impeller as set forth in claim 1 wherein the back plate also serves as a rotary driving member for the impeller.
